(19) United States
(12) Patent Application Publication
(10) Pub. No.: US 2024/0425424 A1
(43) Pub. Date: Dec. 26, 2024

(54) METHOD FOR DEPOSITING AN ENVIRONMENTAL BARRIER ON A PART MADE OF COMPOSITE MATERIAL HAVING A CERAMIC MATRIX

(71) Applicants: SAFRAN CERAMICS, Le Haillan (FR); CENTRE NATIONAL DE LA RECHERCHE SCIENTIFIQUE, Paris (FR); UNIVERSITE DE BORDEAUX, Bordeaux (FR)

(72) Inventors: Francis REBILLAT, Pessac (FR); Lisa PIN, Moissy-Cramayel (FR); Marie SALLES, Paris (FR); Eric BOUILLON, Moissy-Cramayel (FR)

(73) Assignees: SAFRAN CERAMICS, Le Haillan (FR); CENTRE NATIONAL DE LA RECHERCHE SCIENTIFIQUE, Paris (FR); UNIVERSITE DE BORDEAUX, Bordeaux (FR)

(21) Appl. No.: 18/707,133

(22) PCT Filed: Oct. 26, 2022
(86) PCT No.: PCT/FR2022/052029

§ 371 Date: May 2, 2024

(30) Foreign Application Priority Data
Nov. 4, 2021 (FR) FR2111727

(51) Int. Cl. C04B 41/89; C04B 41/00; C04B 41/45

(52) U.S. Cl. CPC C04B 41/89; C04B 41/0009; C04B 41/4531

(57) ABSTRACT

The invention relates to a method for depositing an environmental barrier on a part made of composite material having a ceramic matrix comprising silicon carbide fibres. The method comprises the deposition of a joining layer on at least one surface of the part, the joining layer comprising mullite or a mullite precursor, and the deposition of a protective layer on the joining layer, the protective layer comprising a rare earth disilicate.

### TECHNICAL FIELD

The present disclosure relates to the protection of parts made of ceramic matrix composite material, for example stationary vanes or moving blades of the high-pressure turbine or low-pressure turbine of a turbine engine. In particular, the present disclosure relates to a method for depositing an environmental barrier on a part made of ceramic matrix composite material comprising silicon carbide fibres.

### PRIOR ART

Parts made of carbide-based ceramic matrix composite (CMC) material (generally referred to as SiC/SiC) have been developed for the production of high-pressure and low-pressure turbine parts, with the aim of reducing, or even eliminating, the flow of coolant conventionally used in the design of metallic parts made of nickel-based and/or cobalt-based alloy. This advantage is linked to the intrinsic refractory properties of SiC ceramics, allowing an increase in the operating temperatures of turbines, while reducing the Cs, in other words the specific fuel consumption of a turbine engine (a consequence of reducing the intake of coolant air).

However, in the oxidising/corrosive environment of a turbine, SiC/SiC CMCs are subject to a non-passivating corrosion/recession phenomenon, which results from the oxidation taking place during the formation of SiO₂, and the volatilisation of this oxide under the effect of H₂O. Thus, for high temperature applications in an O₂/H₂O environment, the application of a protective coating is necessary on SiC/SiC CMCs.

The protective coating applied is then referred to as an environmental barrier (called an “environmental barrier coating”, EBC) and is composed of a bonding layer made of silicon (also referred to as a “bond coat”), and a layer ensuring protection against corrosion of the system, made of a rare earth silicate ReSiO (also called a “top coat”). The coating must comply with a certain number of constraints: an expansion coefficient that is compatible with that of the CMC substrate, a low permeability for oxidising/corrosive species (which includes both molecular diffusion directly linked to the physical hermeticity parameter and ionic diffusion of O═ and OH— species, which are intrinsic characteristics of RESiO) and thermomechanical stability at the operating temperatures of the part.

Currently developed EBCs are composed of a layer of silicon (bond coat) “silico-former” which can ensure protection against oxidation of SiC/SiC, by forming a layer of passivating silica (called “thermal growth oxide”, TGO), that forms during the stabilisation treatment of the EBC and able to give rise to continuous growth in operation, linked with the level of hermeticity of the EBC and a layer of rare earth disilicate Re₂Si₂O₇ (generally, Re=Y (yttrium), Yb (ytterbium) or YYb) which can act as a diffusion barrier for oxidising species and protect the CMC against corrosion at high temperature.

Although the silico-former has a beneficial protective effect for the SiC/SiC against oxidation, the growth of the TGO can have induced thermomechanical effects: generating stresses at the bond-coat/top-coat interface (BC/TC), linked to the volumetric increase Si→SiO₂ (·v/v=120%) and the allotropic transformation of silica associated with a change in volume (·-->· at 250° C.; ·v+4%). Above a critical thickness of TGO, in operation, the state of stresses at the BC/TC interphase can exceed a rupture criterion, giving rise to cracking and leading, ultimately, to partial or total spalling of the top coat, and therefore to loss of the anti-corrosion function.

Moreover, the presence of the silicon layer limits the temperature of use of this type of EBC. More specifically, since the melting temperature of silicon is 1415° C., the maximum temperature of use for such a system cannot exceed 1300-1350° C.

However, for certain CMCs, the temperature of the BC/TC interface must be able to withstand temperatures of up to 1450° C.

It is therefore of interest to have a bonding layer that enables temperatures of use of the EBC ranging from 1000° C. to 1450° C., while improving the lifespan of the coating by avoiding the formation of an oxide on the adhesion layer, having an allotropic transformation at temperatures less than 1450° C.

### DISCLOSURE OF THE INVENTION

The present disclosure aims to at least partially overcome these disadvantages.

For this purpose, the present disclosure relates to a method for depositing an environmental barrier on a part made of ceramic matrix composite material comprising silicon carbide, the method comprising:
obtaining a bonding layer on at least one surface of the part, the bonding layer comprising mullite or a mullite precursor;

obtaining a protective layer on the bonding layer, the protective layer comprising a rare earth disilicate.

Mullite (3Al₂O₃·2SiO₂) is a refractory oxide having low coefficients of thermal diffusivity and thermal expansion (4.5 i.e. identical to SiC/SiC CMC). It also has a low coefficient of diffusion for humidity and oxygen, and good resistance to volatilisation in a humid environment at high temperature. Furthermore, mullite does not undergo allotropic transformations in the range of temperatures of use, thus making it possible to limit the thermomechanical stresses generated at the bonding layer (BC)/protective layer (TC) interface, and thus having a better resistance to spalling.

The bonding layer (or bond coat) is deposited on the surface of the part. It is also understood that the bonding layer, comprising mullite or mullite precursors able to form mullite, is deposited directly on the surface of the part.

The protective layer (or top coat) is deposited on the bonding layer, so that the bonding layer is inserted between the part and the protective layer.

In certain embodiments, when the bonding layer comprises the mullite precursor, an oxide layer is formed at the interface of the bonding layer and the protective layer, the oxide layer being formed by oxidation of the mullite precursor of the bonding layer and the oxide layer comprising mullite.

The choice of mullite precursor for the bonding layer is also guided by the need to form an oxide (TGO) that is stable to ageing at the BC/TC interface by reaction with oxidising species from the environment.

In certain embodiments, the mullite precursor can comprise a mixture of silicon carbide (SiC) and aluminium nitride (AlN).

The SiC+AlN mixture makes it possible to generate the mullite layer by oxidation. More specifically, SiC and AlN form a continuous solid solution, leading to an intimate mixture of elements, promoting an increased reactivity between the oxides formed, SiO₂ and Al₂O₃, in order to form mullite and chemically bond the silica before it volatilises.

In certain embodiments, the mullite precursor can comprise alumina.

By way of non-limiting examples, the mullite precursor can comprise a mixture of silicon carbide and alumina or a mixture of silicon nitride and alumina.

In certain embodiments, the mullite precursor can comprise silicon boride or aluminium boride.

By way of non-limiting examples, the mullite precursor can comprise a mixture of silicon boride and aluminium nitride, a mixture of silicon boride and alumina, a mixture of silicon carbide and aluminium boride or a mixture of silica and aluminium boride.

In certain embodiments, the mullite precursor can comprise an intermetallic compound of silicon and/or aluminium.

By way of non-limiting examples, the mullite precursor can comprise an aluminium-based and hafnium-based alloy, aluminium-based and titanium-based alloy, an SiₓM_{y} alloy where M is a metal or a rare earth.

In certain embodiments, the atomic ratio aluminium:silicon of the mullite precursor can be 3:2.

The ideal quantities between these compounds are in the stoichiometric ratio Al/Si of the mullite: 3Al/2Si.

In certain embodiments, the bonding layer can be obtained by flash sintering.

In certain embodiments, the protective layer can be obtained by flash sintering.

In certain embodiments, the bonding layer can be obtained by chemical vapour deposition.

In certain embodiments, the rare earth disilicate can comprise an yttrium disilicate.

In certain embodiments, the ceramic matrix can comprise silicon carbide.

By way of non-limiting examples, the ceramic matrix can be silicon carbide or a mixture of silicon carbide and aluminium nitride.

### BRIEF DESCRIPTION OF THE FIGURES

Other features and advantages of the subject matter of the present invention will emerge from the following description of embodiments, provided by way of non-limiting examples, with reference to the accompanying figures.

FIG. 1 is a schematic longitudinal sectional view of a turbine engine.

FIG. 2 is a flow diagram showing the steps of a method for depositing an environmental barrier.

FIGS. 3A-3B are sectional views in backscattered electrons of the bonding layer and the protective layer (A) before thermal ageing (B) and after thermal ageing for 500 hours at 1300° C. in humid air (air/H₂O: 50/50 kPa).

In all of the figures, the elements in common are labelled by identical numerical reference signs.

### DETAILED DESCRIPTION

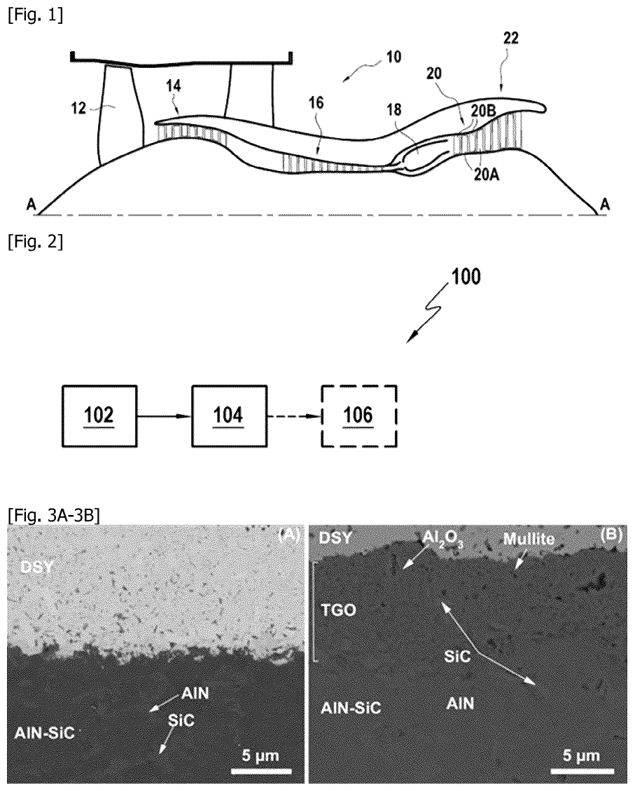

FIG. 1 shows a turbofan engine 10 in cross-section along a vertical plane passing through its principal axis A. The turbofan engine 10 includes, from upstream to downstream in the circulation of the air flow, a fan 12, a low-pressure compressor 14, a high-pressure compressor 16, a combustion chamber 18, a high-pressure turbine 20 and a low-pressure turbine 22.

The high-pressure turbine 20 comprises a plurality of moving blades 20A turning with the rotor, and flow straighteners 20B mounted on the stator. The stator of the turbine 20 comprises a plurality of stator rings disposed opposite the moving blades 20A of the turbine 20.

Similarly, the low-pressure turbine 22 comprises a plurality of moving blades turning with the rotor, and flow straighteners mounted on the stator.

The method 100 for depositing an environmental barrier on a part made of ceramic matrix composite material comprising silicon carbide fibres will be described.

By way of non-limiting example, the part made of ceramic matrix composite material comprising silicon carbide fibres can be an SiC/SiC fixed vane or moving blade, for example for the low-pressure turbine and/or for the high-pressure turbine.

By way of non-limiting example, the bonding layer can comprise a mullite precursor comprising a mixture of silicon carbide and aluminium nitride, for example with an atomic ratio Al/Si equal to 3:2.

The protective layer can comprise yttrium disilicate (Y₂Si₂O₇).

The bonding layer and the protective layer can, for example, be obtained by flash sintering, also called SPS for “spark plasma sintering”, or FAST for “field assisted sintering technique” or PECS for “pulsed electric current sintering” or by CVD for “chemical vapour deposition” or by PVD for “physical vapour deposition”.

FIG. 3A is a sectional view by backscattered electrons of the bonding layer made of SiC—AlN and of the protective layer made of Y₂Si₂O₇ (DSY) after obtaining the bonding layer (step 102) and obtaining the protective layer (step 104).

After oxidation for 500 hours at 1300° C. under humid air (air/H₂O: 50/50 kPa), an oxide layer (TGO) is formed at the interface of the bonding layer and the protective layer, the oxide layer is formed by oxidation of the mullite precursor of the bonding layer, and the oxide layer comprises mullite (FIG. 3B).

It is understood that step 106 of oxidising the bonding layer can be partially carried out before use of the turbine engine and can be completed during the use of the turbine engine, in other words in-flight in the case of an aircraft turbojet.

After ageing for 500 hours of oxidation at 1300° C., under humid air (air/H₂O=50/50 kPa), an oxide layer (TGO) mainly of mullite is formed. The quantity of silica becomes extremely limited at the bonding layer/oxide layer and oxide layer/protective layer interfaces. The unreacted alumina remains present temporarily.

These interfaces are continuous and strongly bonded. In contrast to the silica layer formed by oxidation of Si, this mullite TGO does not have any allotropic changes, limiting its volume variations, apart from those of growth. No crack is detected in this restricted zone, and the risk of delamination is thus strongly reduced close to these interfaces.

Instead of obtaining a bonding layer comprising a mullite precursor and partially oxidising this bonding layer, it is possible to obtain a bonding layer comprising mullite, for example by chemical vapour deposition.

Although the present disclosure has been described by referring to a specific exemplary embodiment, it is obvious that various modifications and changes can be made to these examples without going beyond the general scope of the invention as defined by the claims. In addition, the individual features of different embodiments mentioned can be combined in additional embodiments. Consequently, the description and the drawings should be considered as illustrating rather than limiting.

1. A method for depositing an environmental barrier on a part made of ceramic matrix composite material comprising silicon carbide fibres, the method comprising:
obtaining a bonding layer on at least one surface of the part, the bonding layer comprising a mullite precursor;
obtaining a protective layer on the bonding layer, the protective layer comprising a rare earth disilicate;
forming an oxide layer at the interface of the bonding layer and the protective layer, the oxide layer being formed by oxidation of the mullite precursor of the bonding layer and the oxide layer comprising mullite.

2. (canceled)

3. The method according to claim 1, wherein the mullite precursor comprises a mixture of silicon carbide and aluminium nitride.

4. The method according to claim 1, wherein the mullite precursor comprises alumina.

5. The method according to claim 1, wherein the mullite precursor comprises silicon boride or aluminium boride.

6. The method according to claim 1, wherein the mullite precursor comprises an intermetallic compound of silicon and/or aluminium.

7. The method according to claim 1, wherein the atomic ratio of aluminium:silicon of the mullite precursor is 3:2.

8. The method according to claim 1, wherein the bonding layer is obtained by flash sintering.

9. The method according to claim 1, wherein the protective layer is obtained by flash sintering.

10. The method according to claim 1, wherein the bonding layer is obtained by chemical vapour deposition.
